(19) United States
(12) Patent Application Publication
(10) Pub. No.: US 2018/0348603 A1
(43) Pub. Date: Dec. 6, 2018

(54) FLASHLIGHT ACCESSORY FOR LIGHT PAINTING

(71) Applicant: Patrick Rochon, Montreal (CA)

(72) Inventor: Patrick Rochon, Montreal (CA)

(21) Appl. No.: 15/990,575

(22) Filed: May 25, 2018

Related U.S. Application Data
(60) Provisional application No. 62/512,435, filed on May 30, 2017.

(51) Int. Cl. G03B 17/56; F21V 17/00; F21V 17/12; F21V 17/06

(52) U.S. Cl. CPC G03B 17/565; F21V 17/06; F21V 17/12; F21V 17/002

(57) ABSTRACT

The present invention describes an apparatus to attach a light diffuser to a flashlight, creating a light brush for light painting. This apparatus is releasably and firmly attached to a flashlight's head, and can withstand sudden forces associated with abrupt changes in direction of movement of the light brush. The apparatus can be quickly modified to give a user a wide choice of light brushes. The apparatus can have either a screw-on mounting base for flashlights with threaded heads, or a clamp-on mounting base for regular flashlights. The apparatus has two jaws to accommodate either one or two light diffusers. The apparatus can also have two sets of jaws that can pivot independently, and can accommodate either flat or tubular light diffusers. The flat light diffusers can be of various shapes, and have rounded bottoms to give the user a range of results.

This application is based on U.S. Provisional application No. 62/512,435, filed on May 30, 2017. The present invention relates to a flashlight-mounted accessory to be used in the art of light painting photography, and more specifically to an apparatus that securely immobilizes a light diffusing element on a flashlight. Features of this invention include quick-change modularity of light diffusing elements and universal connectability to a wide array of commercially-available flashlights.

Light painting photography is an art form that requires a long-exposure camera and a lighting element such as a flashlight or an object that diffuses light. The present invention relates to the latter, an apparatus that holds a light-diffusing object on top of a flashlight.

### BACKGROUND

Painting with light is a form of art where an artist can make surreal images with streaks of light by using a long-exposure camera, a darkened background and a light brush. The light brush is held in the artist's hands as the artist moves the brush through the camera's frame of focus in an artistic manner. This manner, a detailed choreographed pattern of movements (also known as a Kata), can be very slow and methodical, or rapid and aleatory. The result is a photograph with streaks of light that characterize the artist's Kata.

There is known U.S. Pat. No. 9,416,946 for FLASHLIGHT FITTING FOR LIGHT PAINTING PHOTOGRAPHY. This invention is best-suited to flashlights with an on-off switch on the back, and comprises a conical fitting that slips onto the flashlight's head. A light-diffusing element is inserted into the fitting's other end, and is illuminated by the flashlight. The fitting is held on the flashlight's head by a series of ridges, and the light-diffusing element is also held in place by the fitting's ridges. The one disadvantage of this patent over the present invention is the fact that the fitting is not mechanically attached to the flashlight, and the light-diffusing element is not mechanically attached to the fitting. This flaw may lead to the light-diffusing element disconnecting from the flashlight if the artist were to make an abrupt or sudden movement in their Kata beyond the friction tolerances of the fitting's ridges.

### OBJECT OF THE PRESENT INVENTION

The present invention aims to provide a light brush for the art of light painting. This light brush can be attached to a wide assortment of commercially-available flashlights, and be quickly modified to suit the artist's needs. The light brush is securely held on the flashlight to permit the most abrupt movements.

According to Newton's second law (F=mv²/r), the tip of a typical light brush can carry between 2000N and 4000N of centripetal force depending on how fast the artist moves the brush. These forces require inventive hardware as described by this invention. Without such hardware, the brush would fail and the results will be disastrous.

The present invention also aims to allow the artist to quickly swap brush tips in the field depending on the artist's desired end result without compromising the security and safe immobilization of the tip on the brush.

### BRIEF DESCRIPTION OF THE DRAWINGS

FIG. 1 shows a perspective view of the present invention attached to a flashlight.

FIG. 2 shows an exploded view of the present invention's screw-on embodiment.

FIG. 3 shows a perspective view of FIG. 1 without a flashlight.

FIG. 4 shows a side view of FIG. 3 without a light diffuser.

FIG. 5 shows a perspective view of FIG. 4.

FIG. 6 shows a top view of FIG. 4.

FIG. 7 shows a bottom view of FIG. 4.

FIG. 8 shows a perspective side view of FIG. 3.

FIG. 9 shows a side view of another embodiment of the present invention, namely a clamp-on collar.

FIG. 10 shows an exploded view of FIG. 9 with a flashlight.

FIG. 11 shows a perspective view of FIG. 9.

FIG. 12 shows a top view of FIG. 9.

FIG. 13 shows a bottom view FIG. 9.

FIG. 14 shows a perspective view of FIG. 9 with a light diffuser.

FIG. 15 shows a perspective view of yet another embodiment of the present invention, namely a tube adaptor.

FIG. 16 shows an exploded view of FIG. 15 with a flashlight.

FIG. 17 shows an assembled perspective view of FIG. 16 with various tubes.

FIGS. 18 to 22 show still another embodiment of the present invention with a plurality of light diffusers on hinges.

FIG. 23 shows an example of how two light diffusers of FIGS. 18 to 22 can be combined.

FIGS. 24 to 30 show various light diffusers of the present invention.

FIG. 31 shows a light diffuser with laser etchings.

FIG. 32 shows a variety of light diffusers with rounded bottoms.

FIG. 33 shows a range of movement for a light diffuser due to its rounded bottom.

### DETAILED DESCRIPTION OF THE PREFERRED EMBODIMENTS

The preferred embodiments of the present invention aim to provide an artist with a light brush for the art of light painting. The light brush has to be able to withstand forces associated with abrupt changes in direction and be quickly modifiable to give the artist a wide choice of light-diffusing brush tips.

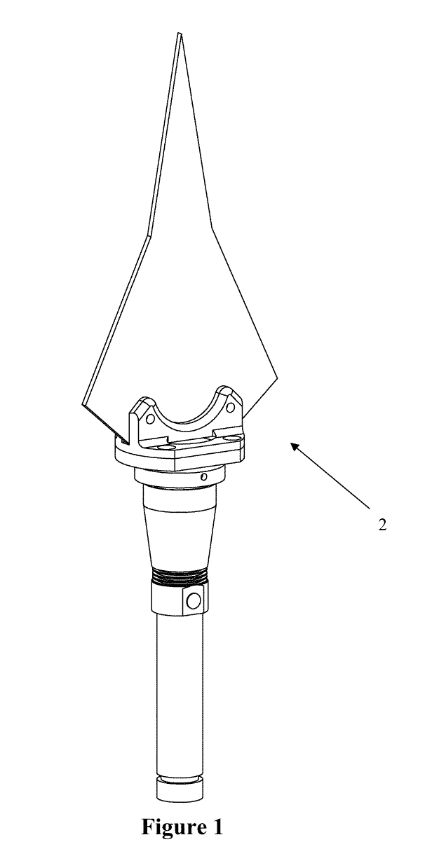

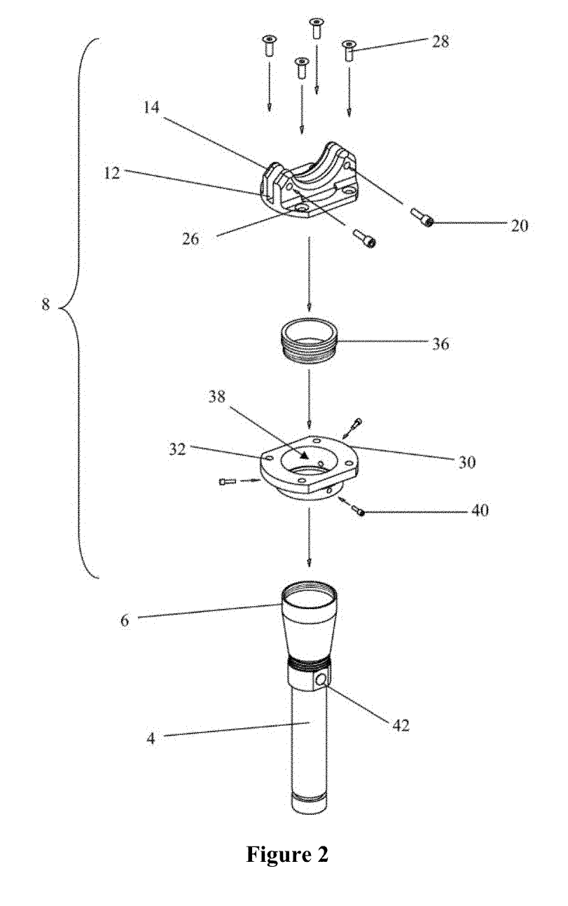

Referring now to drawings, FIG. 1 shows the first preferred embodiment of the present invention, comprising light brush 2 for light painting. FIG. 2 shows an exploded view of FIG. 1 (without light diffuser 10) comprising flashlight 4 with head 6, said head 6 comprising threads for accommodating cylindrical threaded fitting 36. Fitting 36 is inserted inside screw-on mounting base 30, which comprises a cylindrical portion and a horizontal flat portion adapted to mate flush with jaws support 12. Screws 28 attach jaws support 12 to base 30 through holes 26 in jaws support 12 and holes 32 in mounting base 30.

Rotational adjustment screws 40 are inserted into rotational adjustment holes 38 located along the periphery of the cylindrical part of base 30. Screws 40 traverse holes 38 and frictionally lock into a semi-circular valley formed by a ridge around the exterior wall of the top part of threaded fitting 36, thus affixing threaded fitting 36 inside base 30 as well as preventing the assembly from twisting and turning out of the artist's preferred alignment.

The lower portion of threaded fitting 36 comprises threads along the exterior wall that are complimentary to flashlight head 6's threads along the inside wall of head 6. Once threaded fitting 36 is immobilized inside base 30 by screws 40, flashlight adapter 8 can be screwed onto flashlight head 6.

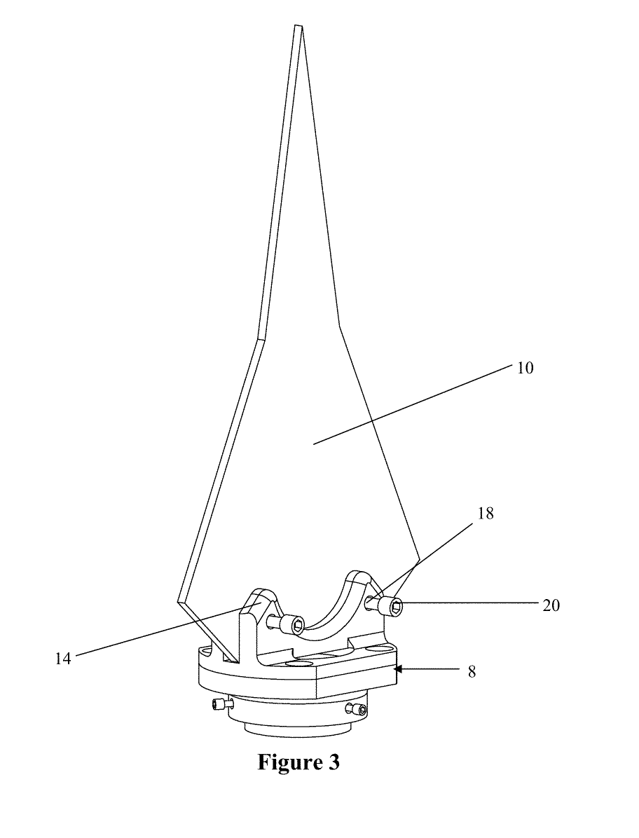

Jaws support 12 comprises two jaws 14 that hold the light diffuser 10 (FIG. 3), said diffuser 10 being immobilized via tightening of jaw screws 20 into holes 18, said holes 18 being located on one of jaws 14.

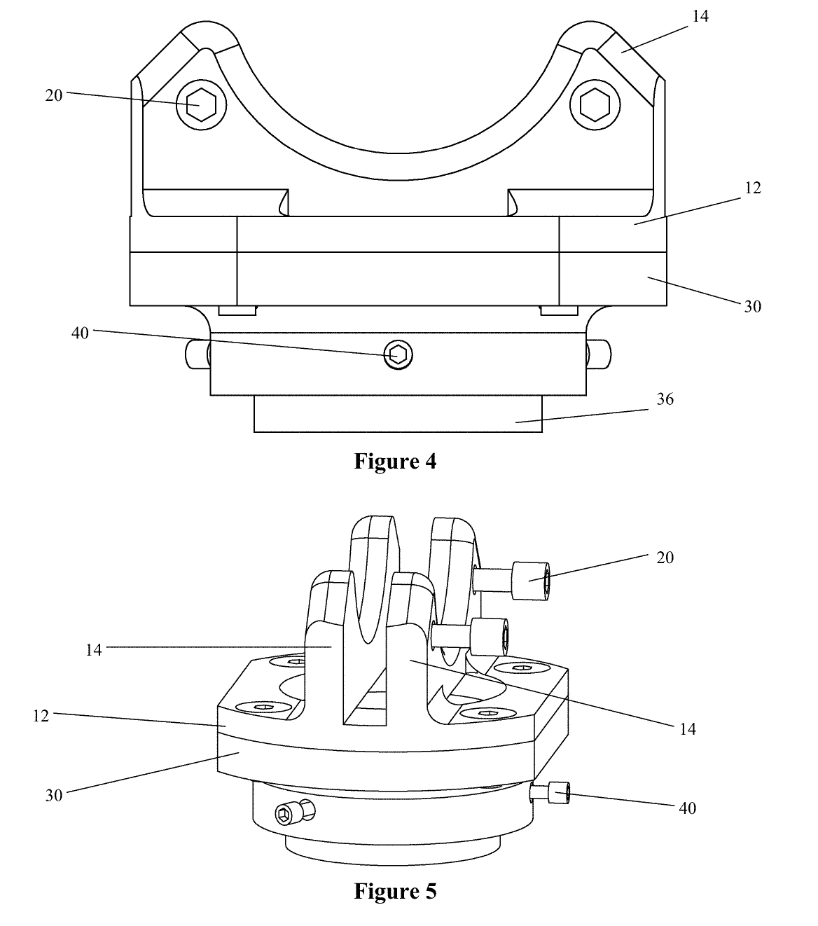

FIG. 3 shows the assembled flashlight adapter 8 with light diffuser 10 being immobilized between jaws 14, held in place with screws 20. FIG. 4 shows adapter 8's jaws 14 of support 12 attached to screw-on mounting base 30 and protruding threaded fitting 36 inside base 30.

FIG. 5 shows jaws 14 integrally attached to jaws support 12, and are oriented vertically.

Jaw screws 20, screwed into jaw holes 18 located on one jaw 14, exert enough pressure onto a light diffuser 10 to prevent diffuser 10 from slipping out of its intended position. Rotational adjustment screws 40 prevent adapter 8 from twisting on flashlight head 6.

FIG. 6 shows a top view of jaws support 12, comprising two jaws 14 protruding perpendicularly to support 12. Also shown are light modifying windows 19 that can be used to enhance light diffuser 10's characteristics. For example, a lighting gel filter can be interposed into window 19 to alter light diffuser 10's effects, or an opaque material can be interposed into window 19 to mute excess light emanating from flashlight 4 onto diffuser 10. Considering there are two windows 19, two differently-colored gel filters can be used.

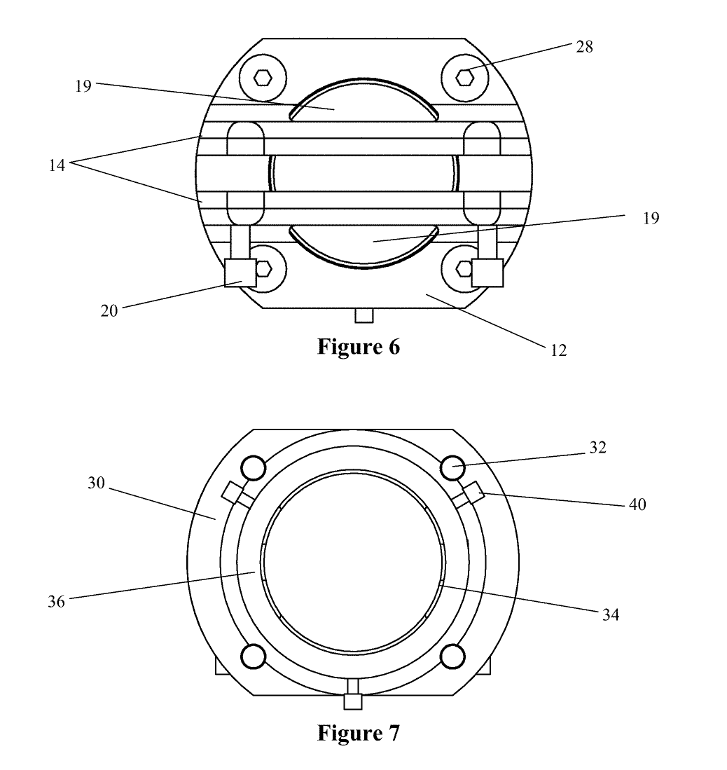

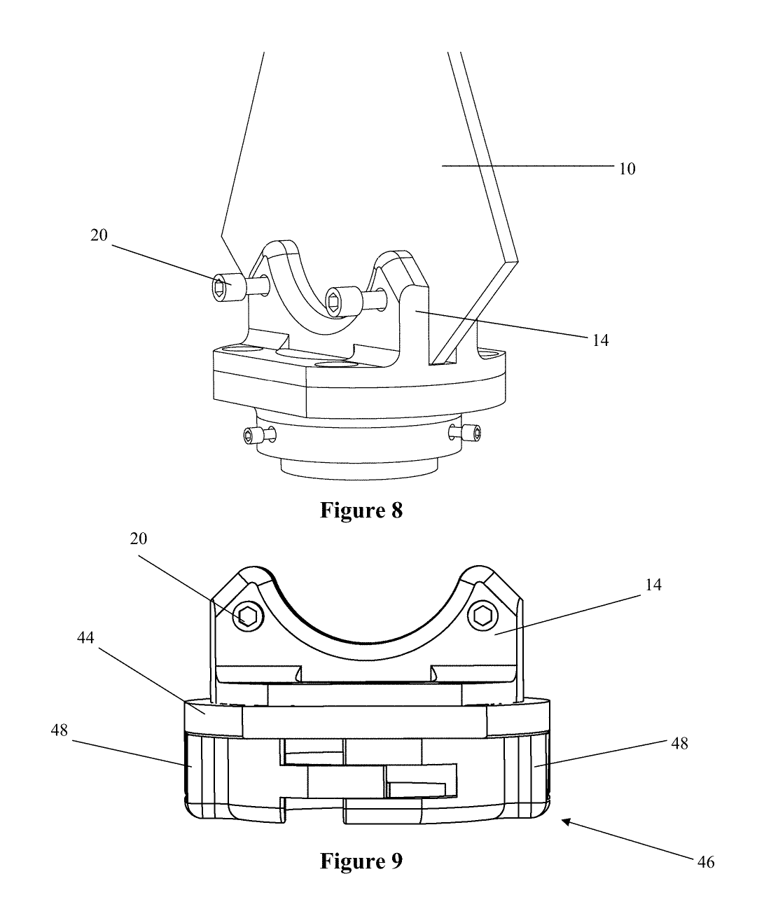

FIG. 7 shows the bottom view of adapter 8 comprising mounting base 30 with threaded fitting 36 incorporating cavity 34 through which light from flashlight 4 passes, rotational adjustment screws 40, and holes 32 in mounting base 30. FIG. 8 shows another view of the screw-on embodiment of flashlight adapter 8 with light diffuser 10 held between jaws 14.

FIG. 9 shows another embodiment of the present invention, being a clamp-on mounting base 44 with jaws 14. Base 44 incorporates clamping collar 46, comprising two half-collars 48 that move slidably on the horizontal axis to securely affix collar 46 around flashlight head 6.

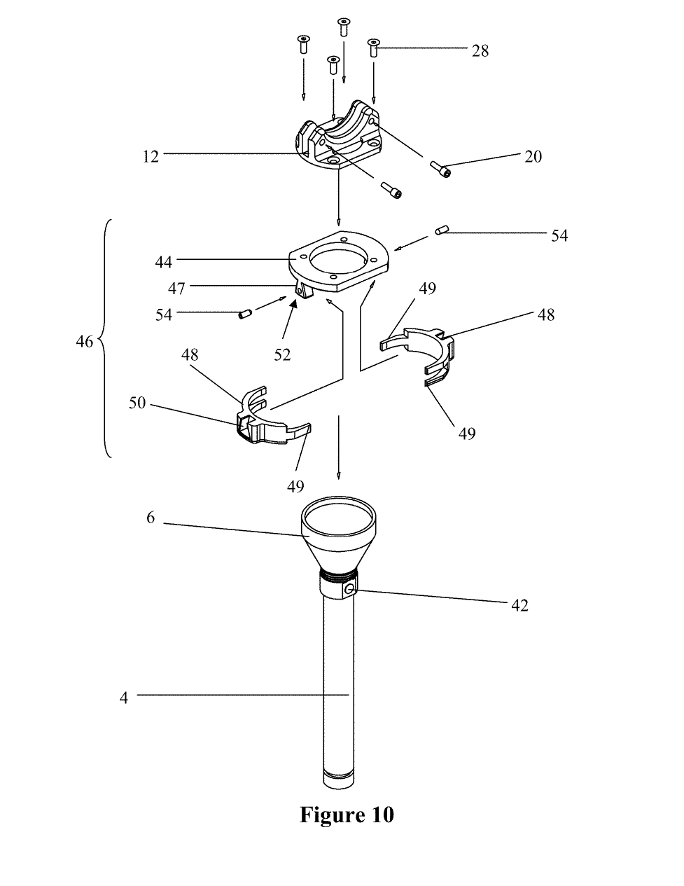

FIG. 10 shows an exploded view of FIG. 9, in relation to flashlight 4 with head 6. Clamping collar 46 comprises clamp-on mounting base 44 and two half-collars 48. Base 44 comprises a flat portion with two depending anchors 47 on each side. Each anchor is provided with a threaded hole 52 for collar clamping screw 54. Each half-collar 48 is of a semi-circle or “C” configuration, provided with one prong 49 on one distal end and two prongs 49 on the other distal end, in such a configuration that the one prong 49 of one half-collar 48 is accommodated in the gap formed between said two prongs 49 of the other half-collar 48. Each half-collar 48 is provided with a tensioning chamber 50 on its outside portion substantially mid-way between said prongs 49, said chamber 50 being able to snugly accommodate base 44's anchor 47.

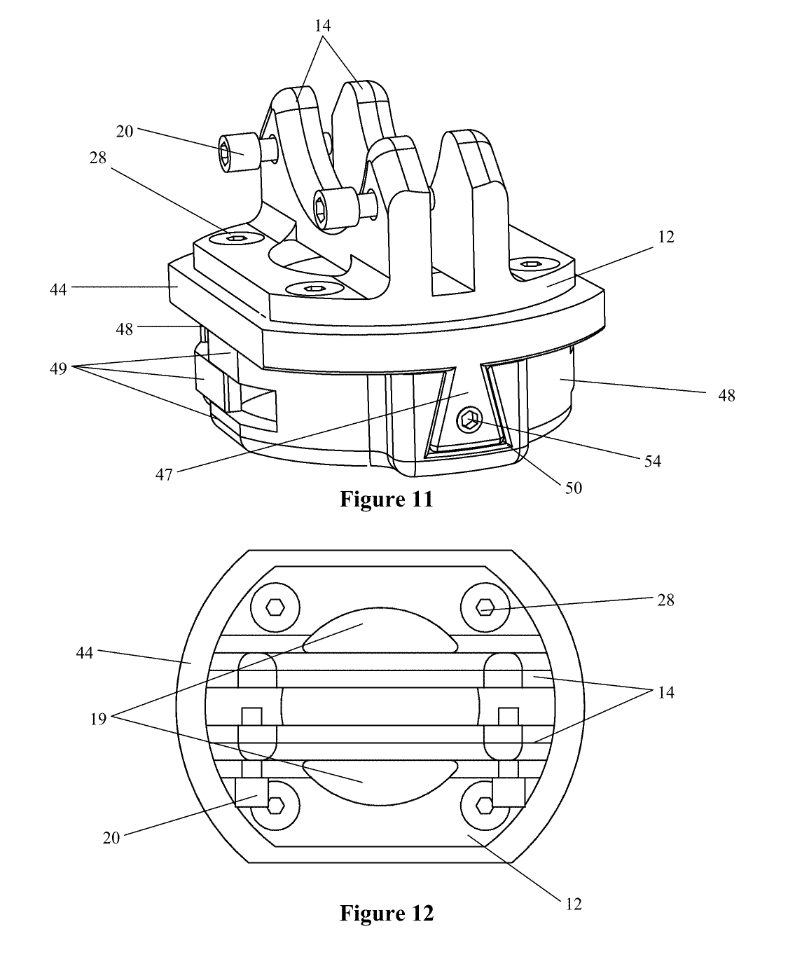

FIG. 11 shows a perspective view of FIG. 9 with jaws support 12 attached to clamp-on mounting base 44 with screws 28, and clamping collar 46, comprising half-collars 48 with prongs 49. Anchor 47 is immobilized inside tensioning chamber 50 with clamping screw 54.

FIG. 12 shows a top view of jaws support 12 attached to base 44, support 12 comprising two jaws 14 protruding perpendicularly to support 12. Also shown are light modifying windows 19 that can be used to enhance light diffuser 10's characteristics. For example, a lighting gel filter can be interposed into window 19 to alter light diffuser 10's effects, or an opaque material can be interposed into window 19 to mute excess light emanating from flashlight 4 onto diffuser 10. Considering there are two windows 19, two differently-colored gel filters can be used.

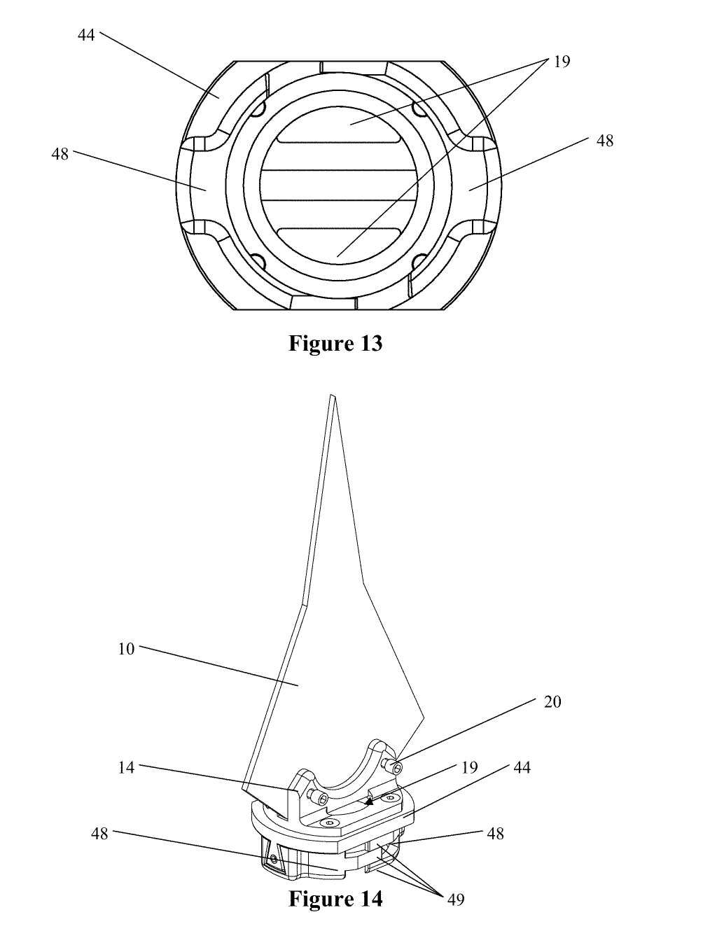

FIG. 13 shows the bottom view of clamp-on base 44 with two half-collars 48 and light-modifying windows 19. FIG. 14 shows the clamp-on base 44 embodiment with light diffuser 10. Light-modifying window 19 is visible between jaws support 12 and jaw 14. Intercooperating prongs 49 of half-collars 48 fit together to prevent clamping collar 46 from dislocating.

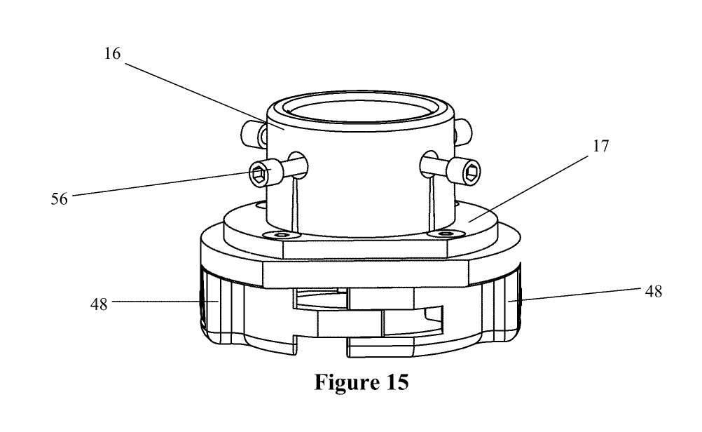

FIG. 15 shows another embodiment of the present invention, adapted for tube-shaped light diffusers 11. This embodiment can be adapted to either the clamp-on base 44 or screw-on base 30, and comprises a tube adapter 16 attached to tube adapter mounting base 17. Tube adapter 16 comprises a cylinder attached to base 17. Base 17 is attached to either clamp-on base 44 of FIG. 10 or screw-on base 30 of FIG. 2.

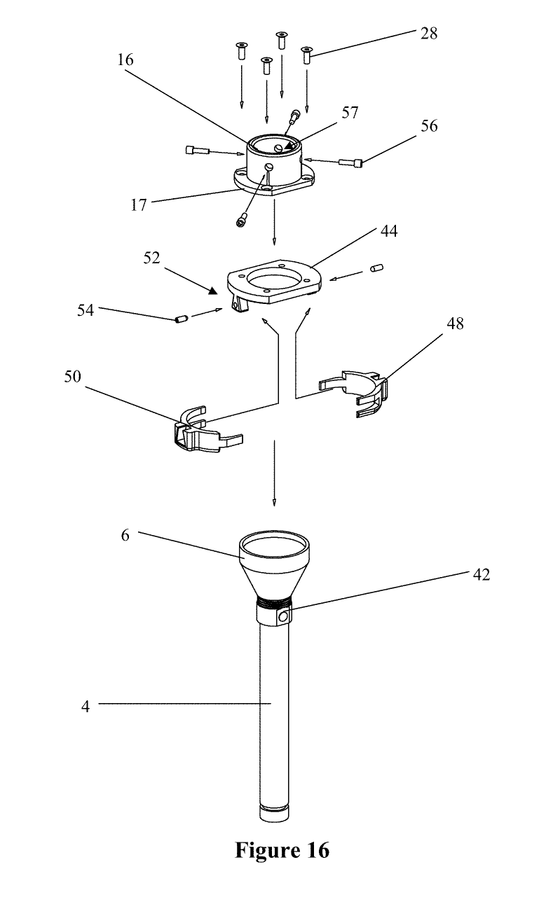

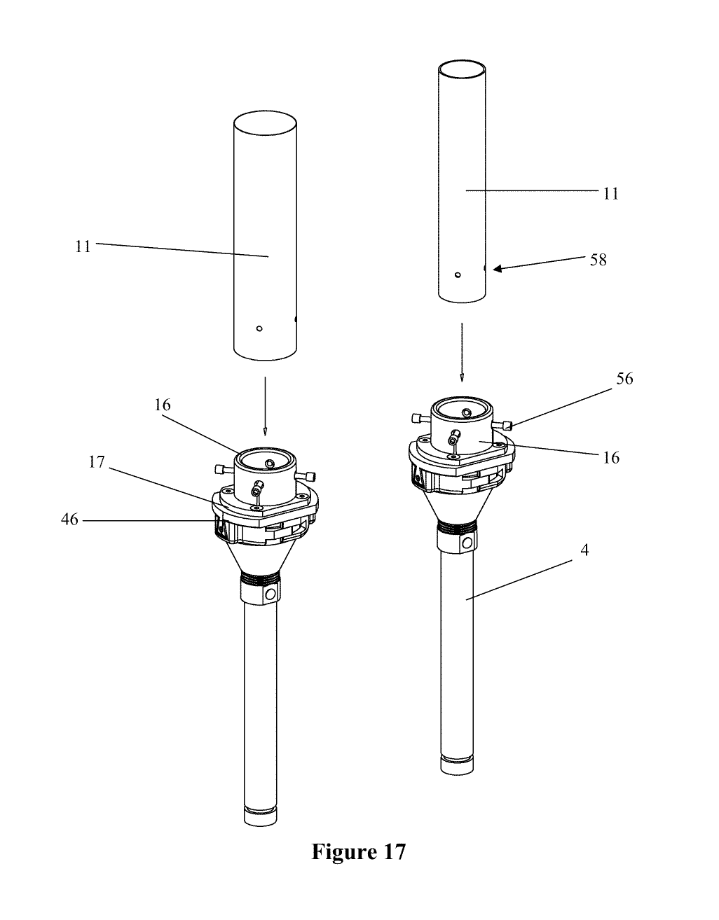

FIG. 16 shows an exploded view of the tube-shaped adapter embodiment. Tube adapter 16 is attached to clamp-on base 44 via screws 28. Clamp-on base 44 is part of clamping collar 46 assembly that attached to flashlight 4's head 6. Screws 56 are inserted through threaded holes 57 around the periphery of tube adapter 16 and serve the purpose of immobilizing tubular light diffuser 11. FIG. 17 shows how tubular light diffuser 11 is attached to tube adapter 16. Light diffuser 11 comprises holes 57 that accommodate screws 56.

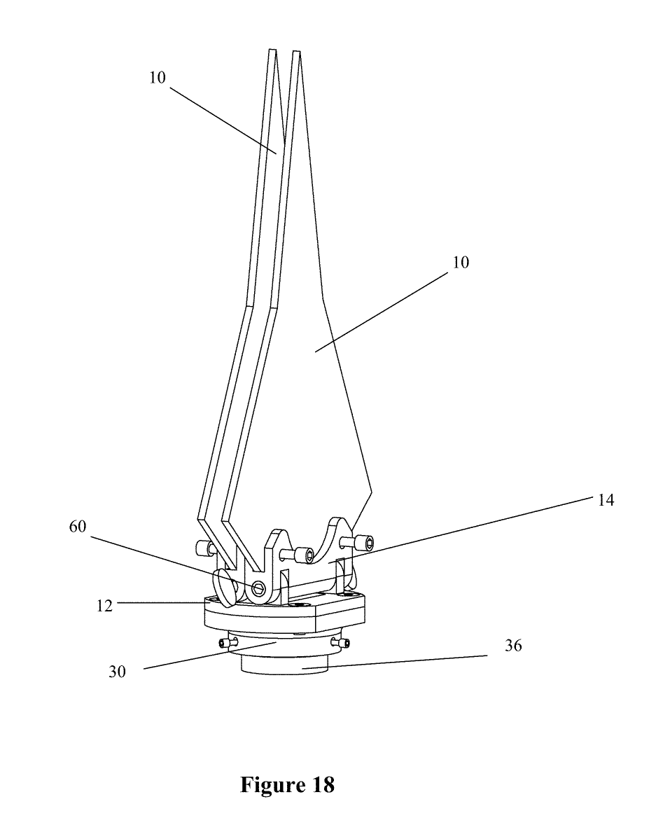

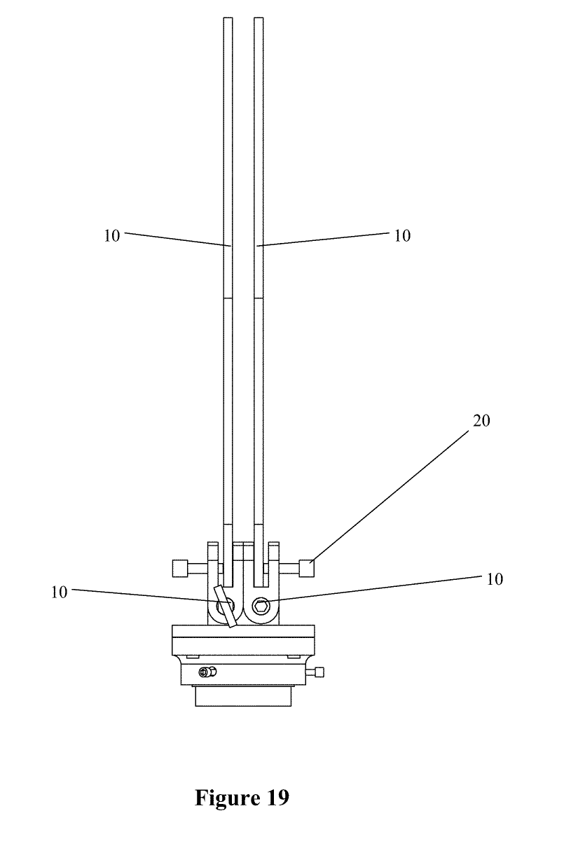

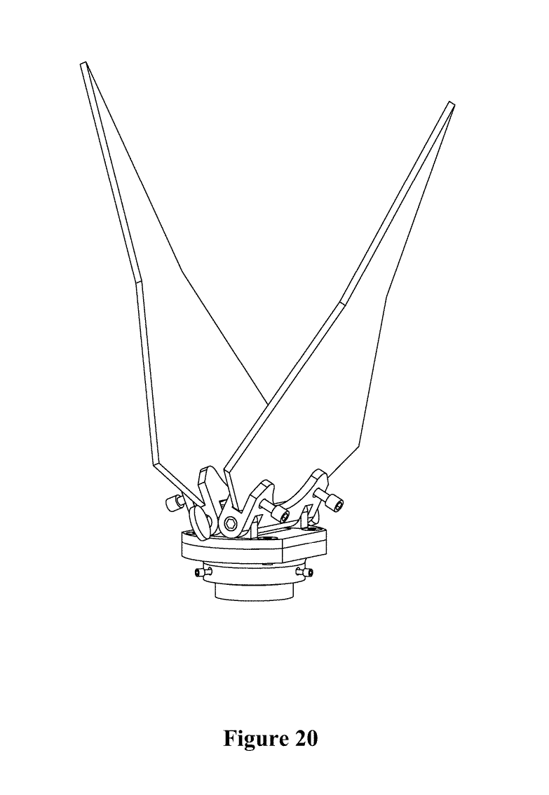

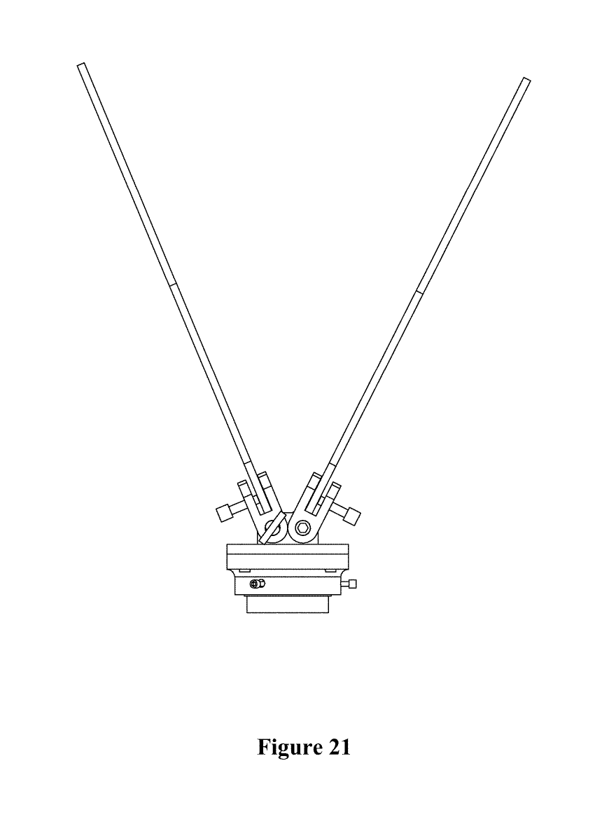

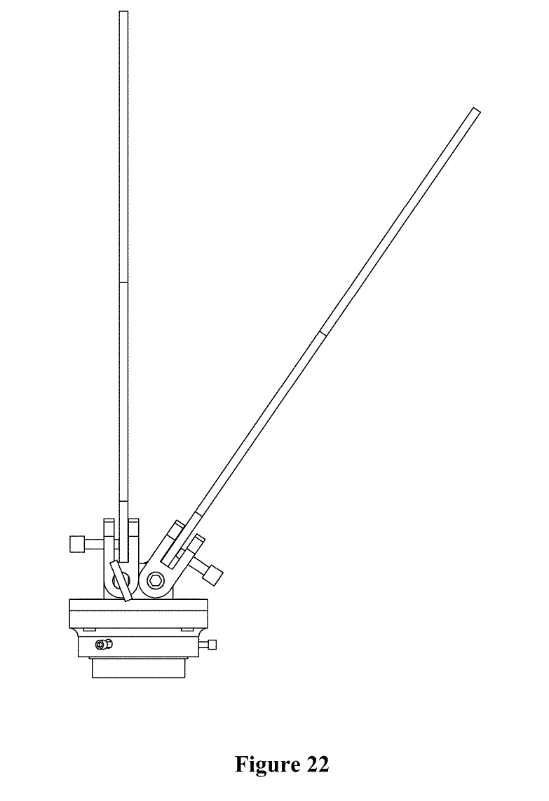

FIGS. 18 to 22 show a variant of the present invention allowing to interpose a plurality of light diffusers 10. In the preferred embodiment of this variant, jaws support 12 accommodates two separate jaws 14, each jaws 14 being mounted on hinge 60 thus being able to pivot along the jaws 14 axis. As seen on FIGS. 18 to 22, jaws 14 of the present variant can be oriented as desired by the user to create lighting effects by light diffusers 10.

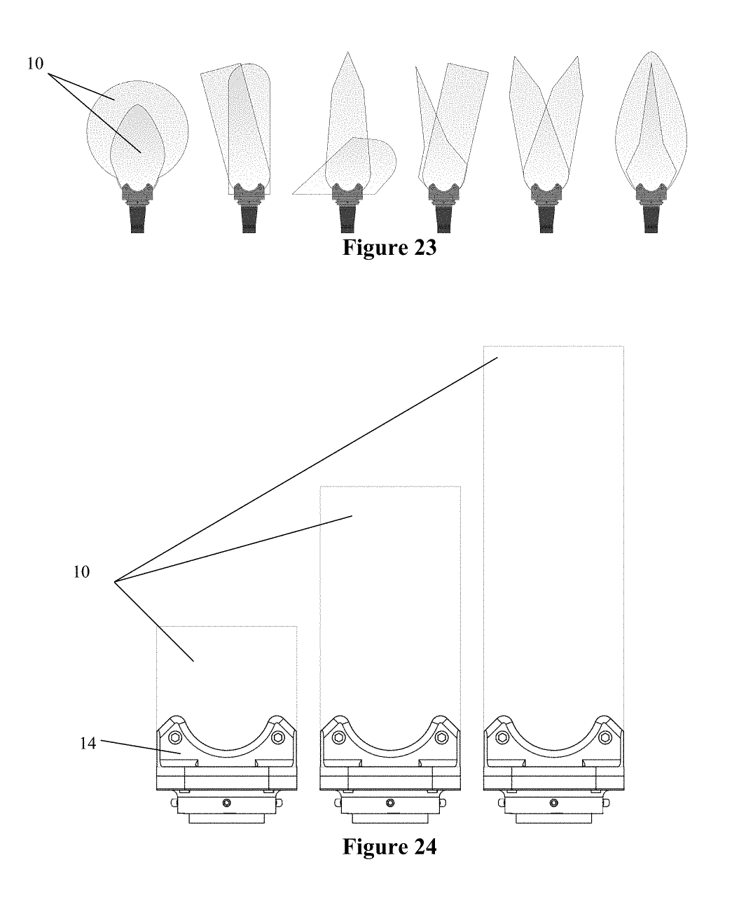

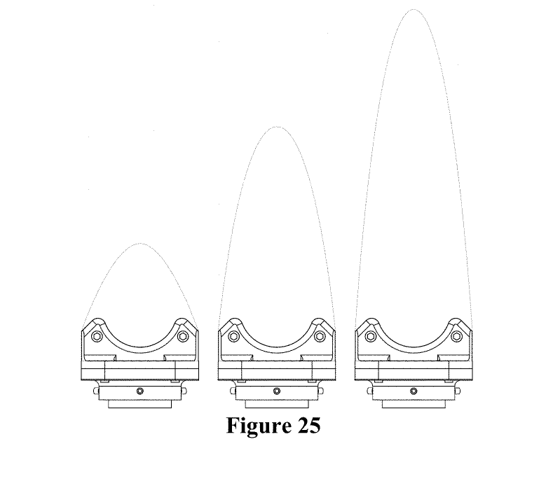

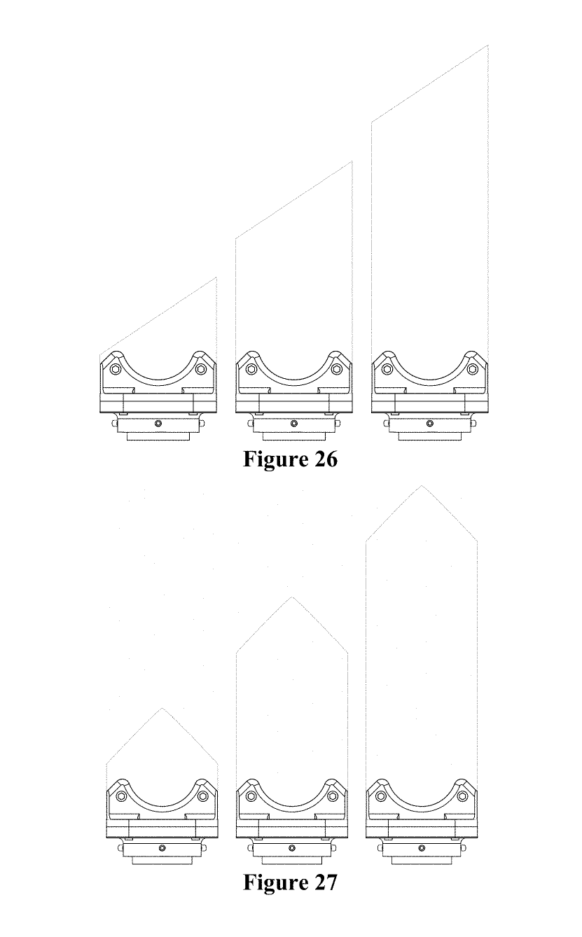

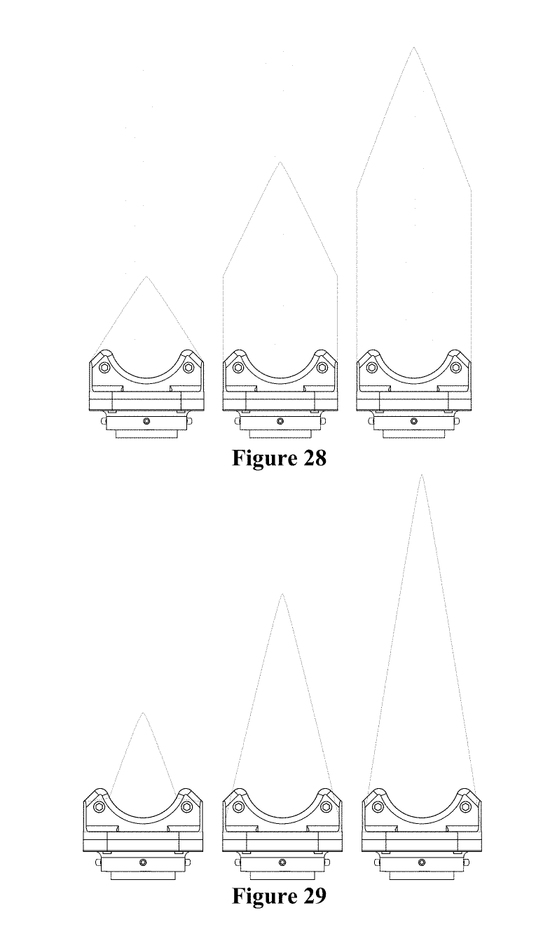

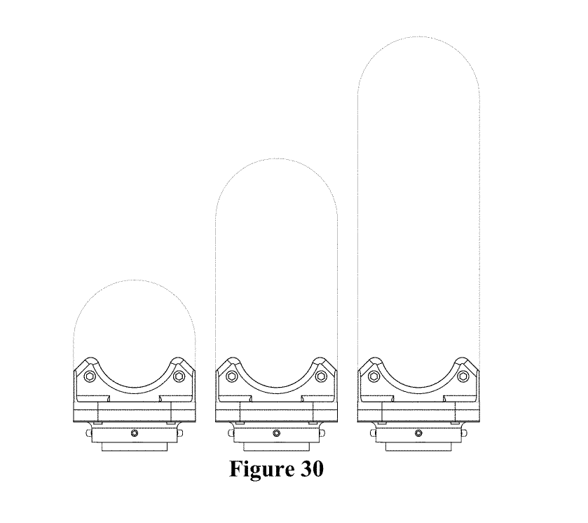

FIG. 23 shows a sample of light diffuser 10 combinations that are possible, either stacked together into one jaws 14 as seen on FIG. 3 or on jaws 14 mounted on hinges 60 as seen on FIGS. 18 to 22. FIGS. 24 to 30 show examples of possible light diffusers 10 that can be used with the present invention.

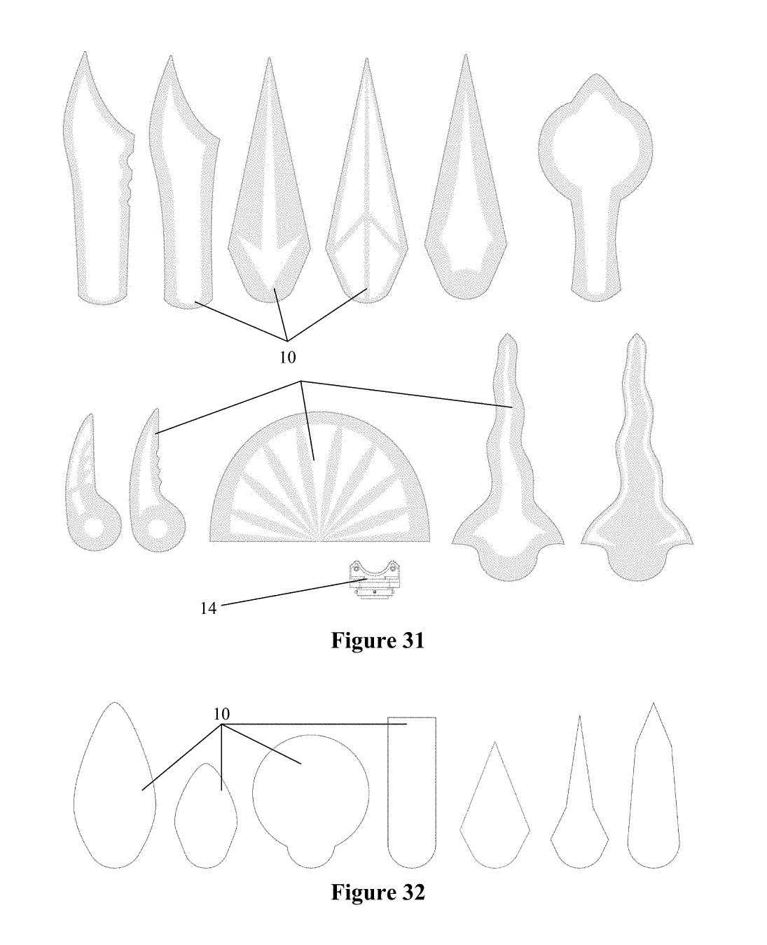

FIG. 31 shows a variant of light diffuser 10 comprising a non-exhaustive collection of etchings that can be accommodated on the inside surface of diffuser 10. In the preferred embodiment of this variant, said etchings can be added by a laser.

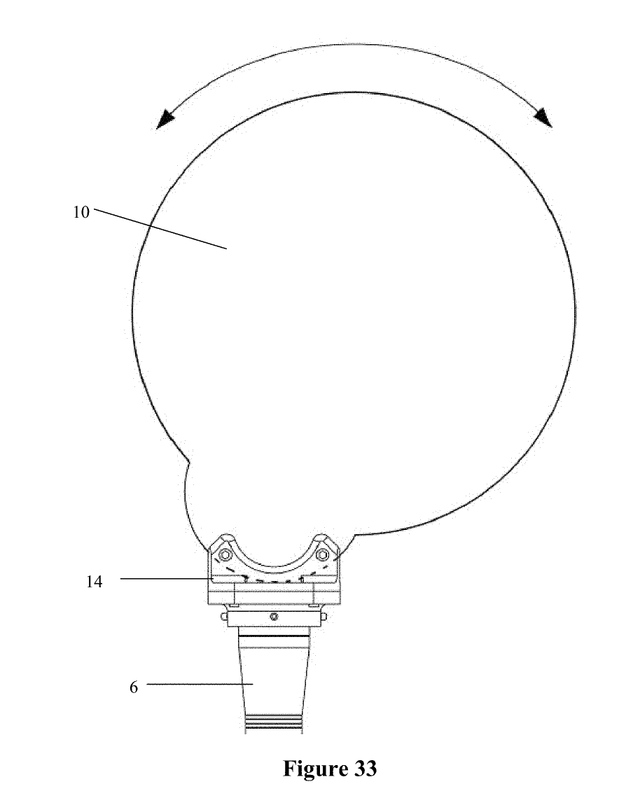

FIG. 32 shows an important feature of the present invention, namely light diffuser 10's rounded bottoms. As seen on FIG. 33, said rounded bottoms permit the artist to orient light diffuser 10 in an eccentric configuration inside jaws 14 to give the artist a desirable effect.

In operation, user inserts light diffuser 10 between jaws 14 and tightens screws 20 through holes 18 so that the tips of screws 20 abut diffuser 10, locking diffuser 10 between jaws 14. User then attaches jaws support 12 to either the screw-on mounting base 30 or clamp-on mounting base 44 by threading screws 28 through holes 26 and screwing them into holes 32. The same jaws support 12 can be used for either screw-on mounting base 30 or clamp-on mounting base 44.

Screw-on mounting base 30 is compatible with flashlights 4 with threaded heads 6, such as Klarus XT11, XT11GT, XT11S, RS11 and XT12. Once threaded fitting 36 is screwed onto flashlight head 6, user can rotate mounting base 30 about flashlight 4's axis and lock said base in place with rotational adjustment screws 40 into holes 38.

If user does not have a flashlight 4 with threaded head 6, user can use clamping collar 46. Collar 46 is assembled as follows: clamp-on mounting base 44 is placed upside-down on a flat surface and one half-collars 48 is placed on top so that anchor 47 fits into chamber 50. The second half-collar is aligned so that prongs 49 mate in such a manner that one half-collar 48's end with a gap between two prongs 49 accommodates one prong 49 of the other half-collar 48. The second half-collar 48's chamber 50 is then inserted into anchor 47 of base 44. Screws 54 are then lightly tightened into holes 52 located in anchors 47.

Both half-collars 48 are then tightened over flashlight 4's head 6, and screws 54 are tightened until their tips tensionally abut the inside of chamber 50, thus locking half-collars 48 together around head 6.

Should user desire to swap light diffuser 10, all user has to do is loosen screws 18 until the previous light diffuser 10 can be removed, and insert a new diffuser between jaws 14. User also has the option to stack light diffusers 10, oriented in various slants, to make a unique light brush 2.

User can add gel filters between head 6 and jaws support 12 to add various colors, as well as interposing diverse gel filters only over windows 19 to create a multi-colored light brush 2.

To use the embodiment shown on FIGS. 15 to 17, user inserts tubular light diffuser 11 into tube adapter 16 and locks it in place with screws 56 that are threaded through holes 57 in adapter 16 and holes 58 in diffuser 11. Again, gel filters can be used between flashlight 4's head 6 and tube adapter 16 to add colors to light brush 2.

For the variant shown on FIGS. 18 to 22, user can insert two light diffusers 10 into jaws 14 and pivot diffusers 10 on hinges 60. Once pivoted, user can lock hinges 60 in place. FIG. 23 shows how two light diffusers 10 can be combined in the embodiment shown on FIGS. 18 to 22.

As can be seen on FIGS. 24 to 30, a wide variety of light diffusers 10 can be used with the present invention. The modular nature of this invention is advantageous, since the same jaws support 12 can be used on either a screw-on mounting base 30 or a clamp-on mounting base 44. The addition of gel filters through windows 19 contribute to the versatility of this invention.

The rounded bottom of light diffuser 10 as seen on FIGS. 32 and 33 allow the user to tilt the light diffuser 10 inside jaws 14 in a range of orientations to get a unique and distinctive light brush result.

1. Apparatus for mounting a light diffuser element for light painting comprising:
a flashlight adapter provided to be releasably and firmly attached to a flashlight's head, said adapter is provided with
a light diffuser, said light diffuser is adapted to be held on said adapter by means of
a holding element,
said apparatus is adapted to withstand forces associated with abrupt changes in direction of movement of said light diffuser, and to be quickly modified to give a user a wide choice of light diffusers.

2. Apparatus for mounting a light diffuser element according to claim 1, wherein said holding element comprises a screw-on mounting base comprising a horizontal flat portion and a cylindrical portion depending from said horizontal flat portion, said holding element further includes a jaws support mounted on top of said screw-on mounting base, said jaws support comprises two jaws extending vertically from said jaws support mounted on said screw-on mounting base,
said jaws are spaced apart on said jaws support to accommodate either two light diffusers or one light diffuser,
said jaws are made of metal.

3. Apparatus for mounting a light diffuser element according to claim 2, wherein said flashlight adapter comprises a threaded fitting inserted into said screw-on mounting base, said treaded fitting is adapted to cooperate with corresponding thread formed inside said flashlight head to prevent separation of said apparatus from said flashlight, and wherein said screw-on mounting base has a number of rotational adjustment screws located on a periphery of said cylindrical part of said base, wherein said screws provided to immobilize said base on said flashlight's head.

4. Apparatus for mounting a light diffuser element according to claim 2, wherein said screw-on mounting base is provided with light modifying windows adapted to enhance said light diffuser's characteristics.

5. Apparatus for mounting a light diffuser element according to claim 1, wherein said holding element comprises a clamp-on mounting base comprising a horizontal flat portion and a cylindrical clamping collar located below said horizontal flat portion, said clamping collar consists of two half-collars slidably attached along the horizontal axis, and adapted to securely affix said collar around said flashlight's head, said holding element further includes a jaws support mounted on top of said clamp-on mounting base, said jaws support comprising two jaws extending vertically from said jaws support, said jaws being spaced apart on said jaws support to accommodate one or more light diffusers.

6. Apparatus for mounting a light diffuser element according to claim 5, wherein each of said half-collars has semi-circular configuration and is provided with one prong formed on one distal end and two prongs formed on another distal end, wherein one prong of one of said half-collars is adapted to be accommodated in a gap formed between said two prongs on said other half-collar, said half-collars are slidably attached to each other along horizontal axis and adapted to securely attach said clamping collar around said flashlight's head.

7. Apparatus for mounting a light diffuser element according to claim 6, wherein said horizontal flat portion of said clamp-on mounting base is provided with depending anchors formed on each side of said horizontal flat portion, and wherein each of said half-collars is provided with a corresponding tension chamber adapted to snugly accommodate said anchors of said horizontal flat portion.

8. Apparatus for mounting a light diffuser element according to claim 1, wherein said holding element comprises a clamp-on mounting base comprising a horizontal flat portion and a circular clamping collar located below said horizontal flat portion, said clamping collar consists of two half-collars slidably attached along horizontal axis, each of said half-collars has a semi-circular configuration and is provided with one prong formed on one distal end and two prongs formed on another distal end, wherein one prong of one of said half-collars is adapted to be accommodated in a gap formed between said two prongs of said other half-collar, said half collars are slidably attached along horizontal axis and adapted to securely attach said collar around said flashlight's head, said holding element further includes a light diffuser support mounted on top of said clamp-on mounting base, said light diffuser support includes a tube adapter mounting base and tube adapter extending vertically from said tube adapter mounting base.

9. Apparatus for mounting a light diffuser element according to claim 1, wherein said holding element comprises a screw-on mounting base comprising a horizontal flat portion and a cylindrical portion depending from said horizontal flat portion, said holding element further includes a jaws support mounted on top of said screw-on mounting base, said jaws support comprises two jaws extending vertically from said jaws support mounted on said screw-on mounting base, each of said jaws is mounted on a hinge that can pivot along a jaws axis, said jaws can be oriented as desired to create light effects by said light diffuser.

10. Apparatus for mounting a light diffuser element according to claim 9, wherein said light diffuser can be provided with numerous configurations of light diffusing elements, as desired by the user.

11. Apparatus for mounting a light diffuser element according to claim 10, wherein said numerous configurations can be achieved by combining two light diffuser elements.

12. Apparatus for mounting a light diffuser element comprising
a flashlight adapter to be releasably and firmly mounted on a flashlight head,
said adapter is provided with
a light diffuser,
said light diffuser is adapted to be held on said adapter by means of
a holding element,
said holding element comprises
a mounting base comprising a horizontal flat portion and cylindrical portion depending from said horizontal portion, said holding element further includes
a light diffuser support element adapted to support said light diffuser,
wherein said light diffuser has numerous configurations.

13. Apparatus for mounting a light diffuser element according to claim 12, wherein said mounting base is a screw-on mounting base, and said light diffuser support element comprises a jaws support mounted on top of said screw-on mounting base, said jaws support comprising two jaws extending vertically from said jaws support, said jaws are spaced apart on said jaws support to accommodate either two light diffusers or one light diffuser.

14. Apparatus for mounting a light diffuser according to claim 13, wherein said flashlight adapter comprises a threaded fitting inserted into said screw-on mounting base, said threaded fitting is adapted to cooperate with a corresponding thread formed inside said flashlight's head to prevent separation of said apparatus from said flashlight, and wherein said screw-on mounting base has a number of rotational adjustment screws located on a periphery of said cylindrical part of said base, wherein said screws are provided to immobilize said base on said flashlight's head.

15. Apparatus for mounting a light diffuser according to claim 12, wherein said screw-on mounting base is provided with light modifying windows provided to enhance said light diffuser characteristics.

16. Apparatus for mounting a light diffuser according to claim 12, wherein said holding element comprises a clamp-on mounting base consisting of a horizontal flat portion and a cylindrical clamping collar located below said of said horizontal flat portion, said clamping collar comprising two half-collars slidably attached along a horizontal axis and adapted to securely affix said collar around said flashlight's head, said holding element further includes a jaw support mounted on top of said clamp-on mounting base, said jaw support comprising two jaws extending vertically from said jaws support, said jaws being spaced apart on said jaws support to accommodate one or more light diffusers.

17. Apparatus for mounting a light diffuser according to claim 16, wherein each of said half-collars has a semi-circle configuration and is provided with one prong formed on one distal end, and two prongs formed on another distal end, wherein one prong of one said half-collar is adapted to be accommodated in a gap formed between said two prongs of said other half-collar, said half-collars are slidably attached along a horizontal axis and are adapted to securely attach said collar around said flashlight's head.

18. Apparatus for mounting a light diffuser element according to claim 17, wherein said horizontal flat portion of said clamp-on mounting base is provided with depending anchors formed on each side of said horizontal flat portion, and wherein each of said half-collars is provided a corresponding tension chamber adapted to snugly accommodate said anchors of said horizontal flat portion.

19. Apparatus for mounting a light diffuser element according to claim 12, wherein said holding element comprises a clamp-on mounting base comprising a horizontal flat portion and cylindrical clamping collar located below said horizontal flat portion, said clamping collar consists of two half-collars slidably attached along horizontal axis, each of said half-collars has a semi-circular configuration and is provided with one prong formed on one distal end two prongs formed on another distal end, wherein one prong of one said half-collar is adapted to be accommodated in a gap formed between said two prongs of said other half-collar, said half-collars are slidably attached along horizontal axis and adapted to securely attach said clamping collar around said flashlight's head, said holding element further includes a light diffuser support mounted on top of said clamp-on mounting base, said light diffuser support includes a tube adapter mounting base of flat configuration and tube adapter extending vertically from said tube adapter mounting base.

20. Apparatus for mounting a light diffuser element according to claim 12, wherein said holding element comprises a screw-on mounting base consisting of a horizontal flat portion and a cylindrical portion depending from said horizontal flat portion, said holding element further includes a jaws support mounted on top of said screw-on mounting base, said jaws support comprises two jaws extending vertically from said jaws support mounted on said screw-on mounting base, each of said jaws is mounted on a hinge which can pivot along a jaws axis, said jaws can be oriented as desired by the user to create light effects by said light diffuser.
